(19) United States
(12) Patent Application Publication
(10) Pub. No.: US 2009/0092098 A1
(43) Pub. Date: Apr. 9, 2009

(54) System and method for updating neighbor base station information in a communication system

(75) Inventor: Chang-Yeon Kim, Suwon-si (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/287,111

(22) Filed: Oct. 6, 2008

(30) Foreign Application Priority Data
Oct. 5, 2007 (KR) 2007-0100487

(51) Int. Cl. H04W 36/00

(52) U.S. Cl. 370/331

(57) ABSTRACT

A method is provided for updating neighbor base station (BS) information by a serving BS in a communication system. The method includes acquiring a neighbor BS list from a base station controller (BSC); sending a request message for requesting an update of information on a neighbor BS to the at least one neighbor BS included in the neighbor BS list; checking if a report message including the neighbor BS's information is received from the neighbor BS; when the report message is received, sending to the neighbor BS a confirm message indicating the normal receipt of the report message; and updating the neighbor BS's information according to the received neighbor BS's information. The neighbor BS list is a list of BSs with which a mobile station (MS) located in a cell of the serving BS can perform a handover.

### CROSS-REFERENCE TO RELATED APPLICATION(S) AND CLAIM OF PRIORITY

The present application claims the benefit under 35 U.S.C. §119(a) of a Korean Patent Application filed in the Korean Intellectual Property Office on Oct. 5, 2007 and assigned Serial No. 2007-100487, the disclosures of which are incorporated herein by reference.

### TECHNICAL FIELD OF THE INVENTION

The present invention relates to a system and method for updating neighbor base station (BS) information in a communication system.

### BACKGROUND OF THE INVENTION

The next-generation communication system has been developing to guarantee high-speed data transmission/reception while ensuring the mobility of mobile stations (MSs). The typical next-generation communication system can include an Institute of Electrical and Electronics Engineers (IEEE) 802.16e communication system. In the IEEE 802.16e communication system, a handover acts as a very important factor in guaranteeing the mobility of MSs. The term ‘handover’ as used herein indicates an operation of allowing an MS in service to receive a seamless service even while moving from one base station (BS) to another BS. That is, the ‘handover’ represents an operation of allowing an MS to move to a target BS from which it can receive a higher-quality service as the quality of the service decreases, which it is receiving from a serving BS to which it now belongs, thereby receiving the seamless service.

In the IEEE 802.16e communication system, in order to support the handover of an MS, the serving BS sends neighbor BS information to the MS using a neighbor BS advertisement or MOBile_NeighBoR_ADVertisement (MOB_NBR-ADV) message.

FIG. 1 is a signaling diagram illustrating a process of updating neighbor BS information by a serving BS in a general communication system.

Referring to FIG. 1, in step 101, a serving BS 100 generates its neighbor BS list at the time the communication system first sets up the serving BS 100, and then proceeds to step 103. Although the list of neighbor BSs can be acquired at the time the serving BS 100 is first set up, the serving BS 100 can also acquire the neighbor BS list from a base station controller (BSC). When generating a MOB_NBR-ADV message, the serving BS 100 includes the neighbor BS list therein. The serving BS 100 stores the neighbor BS list in its radio resource controller (RRC). In step 103, the serving BS 100 sends a Radio_Configuration_Update_Request (Radio_Config_Update_Req) message to a target BS 150, one of the neighbor BSs, to acquire downlink channel descriptor (DCD) information and uplink channel descriptor (UCD) information of the neighbor BSs included in the neighbor BS list. For convenience, it is assumed in FIG. 1 that the neighbor BS list includes one neighbor BS (i.e., target BS 150). However, the neighbor BS list can include a plurality of neighbor BSs. In this case, the serving BS 100 sends the Radio_Config_Update_Req message to all neighbor BSs included in the neighbor BS list.

In step 105, the target BS 150 sends to the serving BS 100 a Radio_Configuration_Update_Report (Radio_Config_Update_Rpt) message with DCD information and UCD information of the target BS 150.

In step 107, the serving BS 100 updates the neighbor BS list so that it includes DCD information and UCD information of the target BS 150.

Although not illustrated in FIG. 1, the target BS 150 may occasionally fail to receive the Radio_Config_Update_Req message sent by the serving BS 100 due to an operational problem. In this case, the target BS 150, since it has failed to receive the Radio_Config_Update_Req message, cannot send a Radio_Config_Update_Rpt message with DCD information and UCD information of the target BS 150 to the serving BS 100, causing a problem that the serving BS 100 cannot acquire DCD information and UCD information of the target BS 150.

Also, even though the target BS 150 has sent the Radio_Config_Update_Rpt message to the serving BS 100, the serving BS 100 may occasionally fail to receive the Radio_Config_Update_Rpt message due to a loss of the Radio_Config_Update_Rpt message. Even in this case, the serving BS 100 cannot acquire DCD information and UCD information of the target BS 150.

In the above-stated message exchange procedure between the serving BS 100 and the target BS 150 for updating DCD information and UCD information of the neighbor BS, since the target BS 150 may occasionally fail to receive the Radio_Config_Update_Req message or the serving BS 100 may occasionally fail to receive the Radio_Config_Update_Rpt message, the neighbor BS information managed by the serving BS 100 may not be identical to the neighbor BS information managed by the target BS 150, making it impossible for the MS to perform handover.

### SUMMARY OF THE INVENTION

To address the above-discussed deficiencies of the prior art, it is a primary aspect of the present invention to address at least the problems and/or disadvantages and to provide at least the advantages described below. Accordingly, an aspect of the present invention is to provide a system and method for updating neighbor BS information in a communication system.

Another aspect of the present invention is to provide a system and method for adding a procedure for sending to a neighbor BS a confirm message indicating the update of neighbor BS information when it is updated in a serving BS information update procedure in a communication system.

Another aspect of the present invention is to provide a system and method in which a serving BS and a neighbor BS each acquire a corresponding neighbor BS list from their upper layer and store the neighbor BS list, thereby updating neighbor BS information regardless of a serving BS's request.

According to one aspect of the present invention, there is provided a method for updating neighbor base station (BS) information by a serving BS in a communication system. The method includes acquiring a neighbor BS list from a base station controller (BSC); sending a request message for requesting update of information on a neighbor BS to the at least one neighbor BS included in the neighbor BS list; checking if a report message including the neighbor BS's information is received from the neighbor BS; when the report message is received, sending to the neighbor BS a confirm message indicating the normal receipt of the report message; and updating the neighbor BS's information according to the received neighbor BS's information. The neighbor BS list is a list of BSs to which a mobile station (MS) located in a cell of the serving BS can perform handover.

According to another aspect of the present invention, there is provided a method for updating neighbor base station (BS) information by a neighbor BS in a communication system. The method includes acquiring a neighbor BS list from a base station controller (BSC); upon perceiving a change in a neighbor BS information of the neighbor BS itself, sending a report message including the changed neighbor BS information to at least one serving BS included in the neighbor BS list; and checking if a confirm message indicating normal receipt of the report message is received from the serving BS. The neighbor BS list is a list of BSs of cells where mobile stations (MSs) are located, which intend to perform handover to a cell of the neighbor BS.

According to further another aspect of the present invention, there is provided a system for updating neighbor base station (BS) information in a communication system. The system includes a serving BS which includes sending a request message for requesting update of information on a neighbor BS to the at least one neighbor BS included in a neighbor BS list acquired from a base station controller (BSC); checking if a report message including the neighbor BS's information is received from the neighbor BS; when the report message is received, sending to the neighbor BS a confirm message indicating the normal receipt of the report message; and updating the neighbor BS's information according to the received neighbor BS's information. The neighbor BS list is a list of BSs to which a mobile station (MS) located in a cell of the serving BS can perform handover.

According to yet another aspect of the present invention, there is provided a system for updating neighbor base station (BS) information in a communication system. The system includes a neighbor BS which includes acquiring a neighbor BS list from a base station controller (BSC); upon perceiving a change in a neighbor BS information of the neighbor BS itself, sending a report message including the changed neighbor BS information to at least one serving BS included in the neighbor BS list; and checking if a confirm message indicating normal receipt of the report message is received from the serving BS. The neighbor BS list is a list of BSs of cells where mobile stations (MSs) are located, which intend to perform handover to a cell of the neighbor BS.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a signaling diagram illustrating a process of updating neighbor BS information by a serving BS in a general communication system;

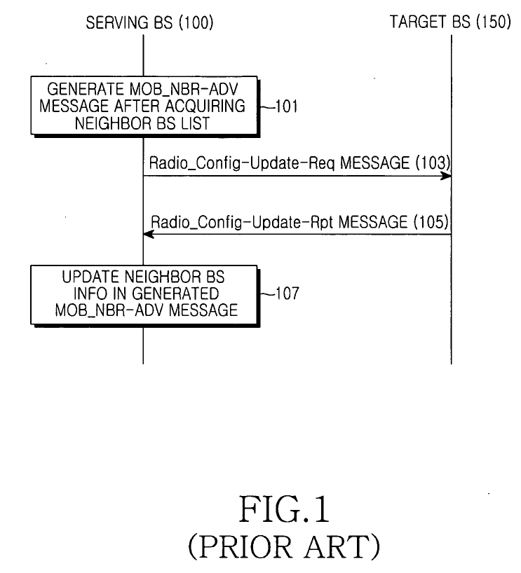

FIG. 2A is a signaling diagram illustrating an exemplary operation of updating neighbor BS information by a serving BS in a communication system according to an embodiment of the present invention;

FIG. 2B is a signaling diagram illustrating another exemplary process of updating neighbor BS information by a serving BS in a communication system according to an embodiment of the present invention;

FIG. 3 is a flowchart illustrating an operation of a serving BS in a communication system according to an embodiment of the present invention; and

FIG. 4 is a flowchart illustrating an operation of a target BS in a communication system according to an embodiment of the present invention.

### DETAILED DESCRIPTION OF THE INVENTION

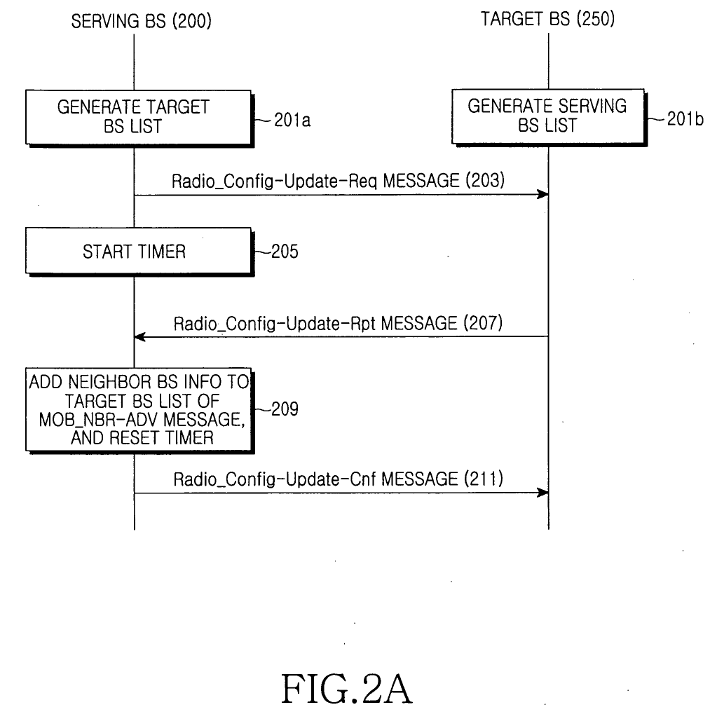

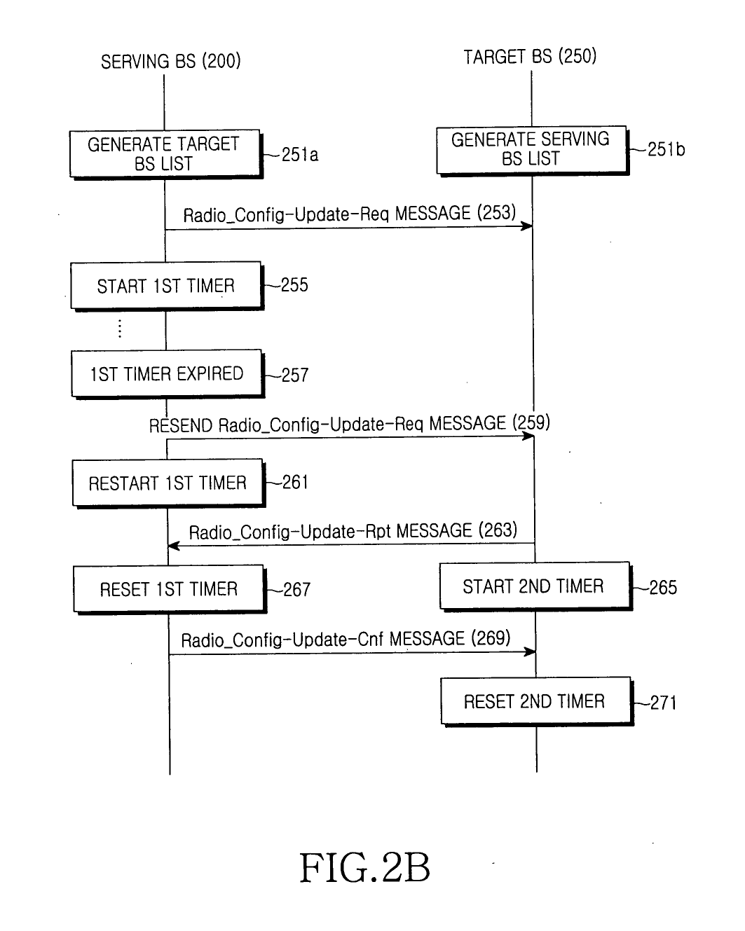

FIGS. 2A through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

The present invention provides a system and method for updating neighbor base station (BS) information in a communication system. Specifically, the present invention provides a system and method in which a serving BS updates a list of neighbor base stations.

For example, an embodiment of the present invention provides a system and method for, when an MS intends to perform handover from its serving BS to a target BS, updating information on each neighbor BS through a message exchange between the serving BS and the target BS to match information on neighbor BSs shared by the serving BS and the target BS. However, the proposed neighbor BS information updating system and method can be applied to a communication system that updates the neighbor BS information and transmits/receives it on a MOB_NBR-ADV message rather than performing the handover of an MS.

Before a description of the present invention is given, a definition will be given of a neighbor BS list stored in each of the serving BS and the target BS.

A serving BS of a cell where an MS is currently located has as its neighbor BS list a target BS list, which is a list of target BSs situated in a cell that the MS intends to enter through handover. The serving BS list is composed of at least one neighbor BS identifier and information (i.e., DCD/UCD information) of its associated neighbor BS. Therefore, the serving BS sends a request for DCD/UCD information to a corresponding target BS and configures a MOB_NBR-ADV message with the target BS information. However, since the target BS has no information on a serving BS list, the serving BS should periodically send a DCD/UCD information request to the target BS, causing generation of traffic unnecessary for the network. When a transmission period of the DCD/UCD information request is increased to reduce the traffic generation, the update time may be delayed, so that handover may not be normally performed.

Therefore, according to the present invention, the target BS has as its neighbor BS list a serving BS list, which is a list of BSs situated in cells where an MS is located, which intend to enter the cell where the MS is located. The target BS list is composed of at least one neighbor BS identifier and information (i.e., DCD/UCD information) of its associated neighbor BS.

To be specific, assume that the communication system is composed of 3 cells of a cell A, a cell B and a cell C. BSs and MSs located in the cell A, the cell B and the cell C are defined as BS_A, BS_B and BS_C, and MS_A, MS_B and MS_C.

As for the cell A where the MS_A is located, the MS_A intends to move from the cell A to the cell B and the MS_B intends to enter the cell A. In this case, a target BS list of the BS A has the BS_B, and a serving BS list of the BS_A has BS_B.

Regarding the cell B where the MS_B is located, the MS_B intends to move from the cell B to the cell A and the MS_A and the MS_C intend to enter the cell B. In this case, a target BS list of the BS_B has the BS_A, and a serving BS list of the BS_B has the BS_A and the BS_C.

Regarding the cell C where the MS_C is located, the MS_C intends to move from the cell C to the cell B and there is no MS intending to enter the cell C. In this case, a target BS list of the BS_C has the BS_B, and a serving BS list of the BS_C has no BS.

The above-defined target BS list and serving BS list of the serving BS and the target BS are acquired from a corresponding BSC(s).

FIG. 2A is a signaling diagram illustrating an exemplary operation of updating neighbor BS information by a serving BS in a communication system according to an embodiment of the present invention.

Referring to FIG. 2A, in step 201a, a serving BS 200 generates a target BS list, and then proceeds to step 203. The target BS list is acquired at the time the communication system first sets up the serving BS 200, or is acquired from a BSC of the serving BS 200. The serving BS 200 stores the target BS list in its RRC. Also, the serving BS 200 stores even its serving BS list. In this case, the serving BS 200 does not include information on a target BS 250 in the target BS list that it includes in a MOB_NBR-ADV message during its generation.

Similarly, in step 201b, the target BS 250 also acquires a serving BS list. The serving BS list is also acquired at the time the communication system first sets up the target BS 250, or is acquired from a BSC of the target BS 250. The acquired serving BS list is stored in an RRC existing in the target BS 250, and the target BS list of the target BS 250 is also stored.

Although not illustrated in FIGS. 2A and 2B, in a transmission period of the MOB_NBR-ADV message, the serving BS 200 periodically sends the MOB_NBR-ADV message to an MS(s).

In step 203, the serving BS 200 sends a Radio_Configuration_Update_Request (Radio_Config_Update_Req) message to the target BS 250, one of neighbor BSs included in the target BS list, to acquire downlink channel descriptor (DCD) information and uplink channel descriptor (UCD) information of the target BSs included in the target BS list, and then proceeds to step 205. The Radio_Config_Update_Req message can be sent at stated periods, or can be sent when necessary.

Although it is assumed herein that the target BS list of the serving BS 200 has only one neighbor BS (i.e., target BS 250) for convenience, the same can be applied to each of a plurality of neighbor BSs when there are the plurality of neighbor BSs.

In step 205, the serving BS 200 starts a timer the moment that it sends the Radio_Config_Update_Req message. The serving BS 200 starts the timer to check if a response message to the Radio_Config_Update_Req message is received during a predetermined time.

Upon receipt of the Radio_Config_Update_Req message, the target BS 250 sends in step 207 a Radio_Configuration_Update_Report (Radio_Config_Update_Rpt) message with DCD information and UCD information of the target BS 250 to the serving BS 200.

In step 209, the serving BS 200 acquires information (i.e., DCD/UCD information) of the target BS 250 through the Radio_Config_Update_Rpt message sent by the target BS 250. Thus, the serving BS 200 adds the acquired information of the target BS 250 to the target BS list in the MOB_NBR-ADV message, and resets the timer.

In step 211, the serving BS 200 sends to the target BS 250 a Radio_Configuration_Update_Confirm (Radio_Config_Update_Cnf) message indicating that it has normally received the Radio_Config_Update_Rpt message sent by the target BS 250.

Although not illustrated in FIG. 2A, the target BS 250, when DCD information or UCD information of the target BS 250 is changed, may send a Radio_Config_Update_Rpt message to the serving BS 200 even though it has not received from the serving BS 200 the Radio_Config_Update_Req message indicating a request for information of the target BS 250. In this case, the target BS 250 marks the change of the DCD information or UCD information in a Change Configuration Count field. For example, ‘0’ indicating the non-change of the information or ‘1’ indicating the change of the information is written in the field.

FIG. 2B is a signaling diagram illustrating another exemplary process of updating neighbor BS information by a serving BS in a communication system according to an embodiment of the present invention.

Referring to FIG. 2B, in step 251a, a serving BS 200 generates a target BS list, and then proceeds to step 253. The target BS list is acquired at the time the communication system first sets up the serving BS 200, or is acquired from a BSC of the serving BS 200. The serving BS 200 stores the target BS list in its RRC. Also, the serving BS 200 stores even its serving BS list. In this case, the serving BS 200 does not include information on a target BS 250 in the target BS list that it includes in a MOB_NBR-ADV message during its generation.

Similarly, in step 251b, the target BS 250 also acquires a serving BS list. The serving BS list is also acquired at the time the communication system first sets up the target BS 250, or is acquired from a BSC of the target BS 250. The acquired serving BS list is stored in an RRC existing in the target BS 250, and the target BS list of the target BS 250 is also stored.

In step 253, the serving BS 200 sends a Radio_Config_Update_Req message to the target BS 250, one of the neighbor BSs included in the target BS list, to acquire DCD information and UCD information of the neighbor BSs included in the acquired target BS list, and then proceeds to step 255. The Radio_Config_Update_Req message can be sent at stated periods, or can be sent when necessary.

Although it is assumed herein that the target BS list of the serving BS 200 has only one neighbor BS (i.e., target BS 250) for convenience, the same can be applied to each of a plurality of neighbor BSs when there are the plurality of neighbor BSs.

In step 255, the serving BS 200 starts a first timer the moment that it sends the Radio_Config_Update_Req message. The serving BS 200 starts the first timer to check if a response message to the Radio_Config_Update_Req message is received during a predetermined time. After the first timer expires in step 257 as the predetermined time has elapsed, if the serving BS 200 has failed to receive a response message to the Radio_Config_Update_Req message, it resends the Radio_Config_Update_Req message to the target BS 250 in step 259.

In step 261, the serving BS 200 restarts the first timer. After the first timer is restarted, the target BS 250, which has received the Radio_Config_Update_Req message, sends in step 263 a Radio_Config_Update_Rpt message with DCD information and UCD information of the target BS 250 to the serving BS 200.

In step 265, the target BS 250 starts a second timer the moment that it sends the Radio_Config_Update_Rpt message to the serving BS 200. The target BS 250 starts the second timer to check if a response message indicating the normal receipt of the Radio_Config_Update_Rpt message is received during a predetermined time.

In step 267, the serving BS 200 acquires information (i.e., DCD/UCD information) of the target BS 250 through the Radio_Config_Update_Rpt message sent by the target BS 250. Thus, the serving BS 200 adds the information of the target BS 250 to the MOB_NBR-ADV message, and resets the first timer.

In step 269, the serving BS 200 sends to the target BS 250 a Radio_Config_Update_Cnf message indicating the normal receipt of the Radio_Config_Update_Rpt message sent by the target BS 250. The Radio_Config_Update_Rpt message includes parameters such as a preamble index, Handover Process Optimization, Mobility Feature Support, Phy Mode ID, and Scheduling Service Supported.

Thereafter, the target BS 250 receives the Radio_Config_Update_Cnf message from the serving BS 200, and resets the second timer in step 271.

Although not illustrated in FIG. 2B, if the serving BS 200 fails to receive a Radio_Config_Update_Rpt message from the target BS 250 before the expiration of the second timer even though it has resent the Radio_Config_Update_Req message to the target BS 250 a predetermined number of times, the serving BS 200 deletes the identifier and information of the target BS 250 from the acquired serving BS list.

Meanwhile, if the target BS 250 cannot occasionally remember the previous history such as a power off (i.e., information indicating from which serving BS the Radio_Config_Update_Req message was received), the target BS 250 may suffer a time delay in synchronizing the lost information. However, since the proposed target BS 250, like the serving BS 200, acquires and stores the serving BS list, if the target BS 250 perceives a change of its information (i.e., DCD information and UCD information), it sends a Radio_Config_Update_Rpt message with its changed DCD information and UCD information to a BS included in the serving BS list (e.g., the serving BS 200) regardless of the receipt of a Radio_Config_Update_Req message from the serving BS 200.

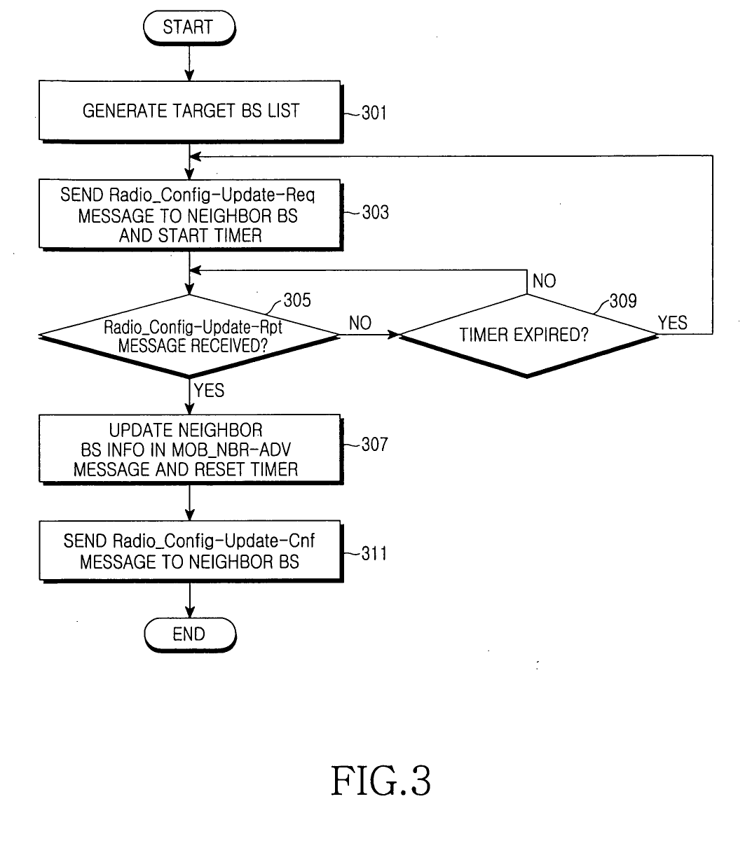

FIG. 3 is a flowchart illustrating an operation of a serving BS in a communication system according to an embodiment of the present invention.

Referring to FIG. 3, in step 301, the serving BS generates a target BS list, and then proceeds to step 303. The target BS list is acquired at the time the communication system first sets up the serving BS, or is acquired from a BSC of the serving BS. In this case, the serving BS does not include information on a desired target BS in the target BS list that it includes in a MOB_NBR-ADV message during its generation. In step 303, the serving BS sends a Radio_Config_Update_Req message to the target BS to acquire information of the target BS, and starts a timer. In step 305, the serving BS checks if it has received a Radio_Config_Update_Rpt message from the target BS. If it is determined that the serving BS has received the Radio_Config_Update_Rpt message, it proceeds to step 307. However, if it is determined that the serving BS has not received the Radio_Config_Update_Rpt message, it proceeds to step 309.

In step 307, the serving BS, which has received the Radio_Config_Update_Rpt message in step 305, acquires information of the target BS included in the received Radio_Config_Update_Rpt message, adds the acquired target BS's information to the MOB_NBR-ADV message, and resets a timer. In step 311, the serving BS sends to the target BS a Radio_Config_Update_Cnf message indicating the normal receipt of the Radio_Config_Update_Rpt message sent by the target BS, and then ends the procedure. The Radio_Config_Update_Rpt message includes parameters such as a preamble index, Handover Process Optimization, Mobility Feature Support, Phy Mode ID, and Scheduling Service Supported.

If it is determined in step 305 that the serving BS has not received the Radio_Config_Update_Rpt message, the serving BS checks in step 309 if timer has expired. If it is determined that the timer has expired, the serving BS returns to step 303 where it resends the Radio_Config_Update_Req message to the target BS and repeats the same procedure.

However, if it is determined in step 309 that the timer has not expired, the serving BS returns to step 305 where the serving BS checks if it has received the Radio_Config_Update_Rpt message from the target BS and repeats the same procedure.

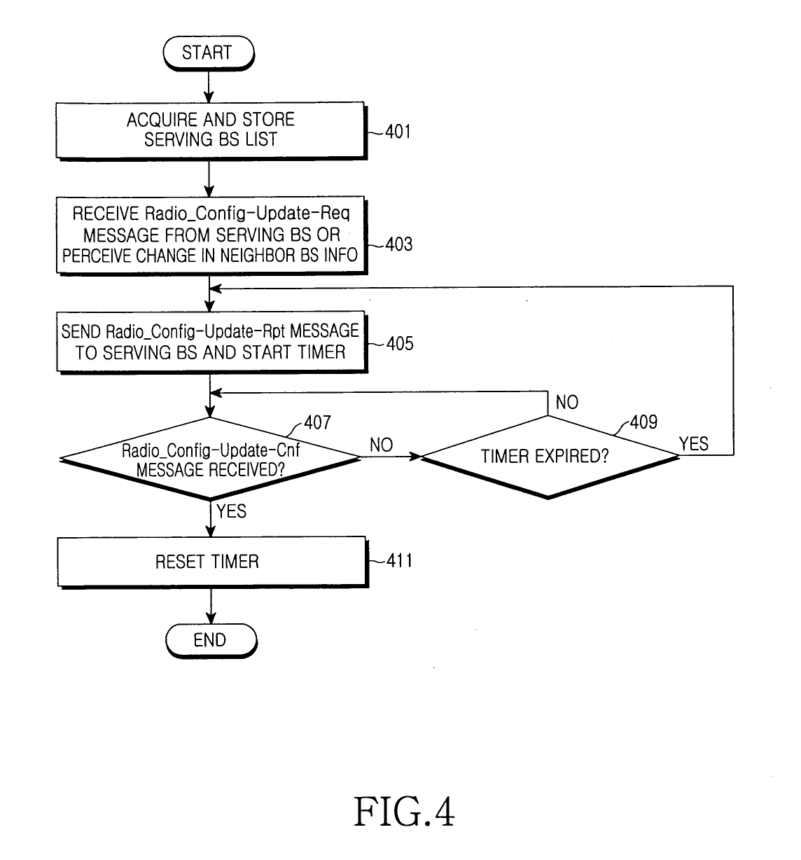

FIG. 4 is a flowchart illustrating an operation of a target BS in a communication system according to an embodiment of the present invention.

Referring to FIG. 4, in step 401, the target BS acquires a serving BS list at the time the communication system first sets up the neighbor BS, or acquires a serving BS list from its BSC. The target BS stores the serving BS list in its RRC.

In step 403, the target BS receives a Radio_Config_Update_Req message from a serving BS. Thereafter, if the target BS perceives a change in its information (i.e., DCD information and UCD information), the target BS sends a Radio_Config_Update_Rpt message to the serving BS and starts a timer in step 405.

Since the target BS acquires and stores the serving BS list, if the target BS perceives a change of its information (i.e., DCD information and UCD information), it sends a Radio_Config_Update_Rpt message with its changed DCD information and UCD information to BSs included in the serving BS list, regardless of the receipt of a Radio_Config_Update_Req message from the serving BS.

In step 407, the target BS checks if it has received a Radio_Config_Update_Cnf message from the serving BS. If it is determined that the target BS has received the Radio_Config_Update_Cnf message, the target BS proceeds to step 411. However, if it is determined that the target BS has not received the Radio_Config_Update_Cnf message, the target BS proceeds to step 409. The Radio_Config_Update_Rpt message includes parameters such as a preamble index, Handover Process Optimization, Mobility Feature Support, Phy Mode ID, and Scheduling Service Supported.

Upon receiving the Radio_Config_Update_Cnf message in step 407, the target BS proceeds to step 411 where it resets the timer and ends the procedure.

However, upon failure to receive the Radio_Config_Update_Cnf message in step 407, the target BS proceeds to step 409 where it checks if the timer has expired. If it is determined that the timer has expired, the target BS returns to step 405 where it resends the Radio_Config_Update_Rpt message to the serving BS and repeats the same procedure.

On the other hand, if it is determined that the timer has not expired, the target BS returns to step 407 where the target BS checks if it has received the Radio_Config_Update_Cnf message from the serving BS, and repeats the same procedure.

As is apparent from the foregoing description, the present invention additionally suggests the Radio_Config_Update_Cnf message indicating the completed update of neighbor BS information when the serving BS exchanges messages to update the neighbor BS information in the communication system, thereby matching the neighbor BS information managed by the serving BS and the target BS. In addition, since the target BS has the serving BS list, the target BS, when its state is changed (e.g., a change in DCD/UCD message or BS restart), transmits the changed information (DCD/UCD) to the serving BS anytime, thus preventing generation of the traffic unnecessary for the network and contributing to a reduction in the time required for updating the neighbor information (DCD/UCD).

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for updating neighbor base station (BS) information by a serving base station in a communication system, the method comprising:
acquiring a neighbor BS list from a base station controller (BSC);
sending a request message to the at least one neighbor base station included in the neighbor BS list;
determining if a report message is received from the neighbor base station corresponding to the request message;
when the report message is received, sending to the neighbor base station a confirm message indicating a normal receipt of the report message; and
updating the at least one neighbor base station included in the neighbor BS list corresponding to a neighbor base station's information included in the request message;
wherein the neighbor BS list is a list of base stations with which a mobile station (MS) located in a cell of the serving base station can perform a handover.

2. The method of claim 1, further comprising:
generating a neighbor BS advertisement message before sending the request message;
wherein the neighbor BS advertisement message includes a neighbor BS list obtained by excluding the at least one neighbor base station's information from the neighbor BS list.

3. The method of claim 2, further comprising:
sending to the mobile station a neighbor BS advertisement message including the neighbor BS list in which the at least one neighbor base station's information is updated.

4. The method of claim 1, further comprising:
when the report message is not received, resending the request message to the at least one neighbor base station a predetermined number of times.

5. The method of claim 4, further comprising:
stopping the resending of the request message when the report message is not received after resending the request message the predetermined number of times; and
deleting the at least one neighbor base station's information from the neighbor BS list.

6. The method of claim 1, further comprising:
after sending the request message, starting a timer; and
releasing the timer after the report message is received.

7. A method for updating neighbor base station (BS) information by a neighbor base station in a communication system, the method comprising:
acquiring a neighbor BS list from a base station controller (BSC);
upon perceiving a change in a neighbor BS information of the neighbor base station itself, sending a report message including the changed neighbor BS information to at least one serving base station included in the neighbor BS list; and
determining if a confirm message indicating a normal receipt of the report message is received from the at least one serving base station;
wherein the neighbor BS list is a list of base stations of cells where mobile stations (MSs) are located, which intend to perform a handover to a cell of the neighbor base station.

8. The method of claim 7, further comprising:
upon receiving a request message from an arbitrary serving base station, sending a report message including the neighbor base station's information corresponding to the request message to the arbitrary serving base station.

9. The method of claim 7, further comprising:
after sending the report message, starting a timer; and
releasing the timer when the confirm message is received.

10. The method of claim 9, further comprising:
when the confirm message is not received, determining if the timer has expired;
if the timer has expired, resending the report message to the serving base station; and
if the timer has not expired, waiting for a reception of the confirm message.

11. A system for updating neighbor base station (BS) information in a communication system, the system comprising:
a serving base station for:
sending a request message to the at least one neighbor base station included in a neighbor BS list acquired from a base station controller (BSC);
checking if a report message corresponding the request message is received from the at least one neighbor base station;
when the report message is received, sending to the neighbor base station a confirm message indicating the normal receipt of the report message; and
updating the at least one neighbor base station's information including in the neighbor list according to the at least one neighbor base station's information including in the report message;
wherein the neighbor BS list is a list of base stations with which a mobile station (MS) located in a cell of the serving base station can perform a handover.

12. The system of claim 11, wherein the serving base station generates a neighbor BS advertisement message before sending the request message;
wherein the neighbor BS advertisement message includes a neighbor BS list obtained by excluding the at least one neighbor BS information from the neighbor BS list.

13. The system of claim 12, wherein the serving base station sends to the mobile station a neighbor BS advertisement message including the neighbor BS list in which the at least one neighbor base station's information is updated.

14. The system of claim 11, wherein when the report message is not received, the serving base station resends the request message to the at least one neighbor base station a predetermined number of times.

15. The system of claim 14, wherein the serving base station stops the resending of the request message when the report message is not received after resending the request message the predetermined number of times; and deletes the at least one neighbor base station's information from the neighbor BS list.

16. The system of claim 11, wherein after sending the request message, the serving base station starts a timer, and releases the timer after the report message is received.

17. A system for updating neighbor base station (BS) information in a communication system, the system comprising:
a neighbor base station for:
acquiring a neighbor BS list from a base station controller (BSC);
upon perceiving a change in a neighbor BS information of the neighbor base station itself, sending a report message including the changed neighbor BS information to at least one serving base station included in the neighbor BS list; and
determining if a confirm message indicating a normal receipt of the report message is received from the at least serving base station;
wherein the neighbor BS list is a list of base stations of cells where mobile stations (MSs) are located, which intend to perform a handover to a cell of the neighbor base station.

18. The method of claim 17, wherein upon receiving a request message from an arbitrary serving base station, the neighbor base station sends a report message including the neighbor base station's information corresponding to the request message to the arbitrary serving base station.

19. The method of claim 17, wherein after sending the report message, the neighbor base station starts a timer; and releases the timer when the confirm message is received.

20. The method of claim 19, wherein if the neighbor base station determines that the timer has expired before the confirm message is received, the neighbor base station resends the report message to the serving base station when the timer has expired, and if the neighbor base station determines that the timer has not expired, the neighbor base station waits for a reception of the confirm message.
